(19) United States
(12) Patent Application Publication
(10) Pub. No.: US 2008/0310539 A1
(43) Pub. Date: Dec. 18, 2008

(54) SYSTEMS AND METHODS FOR GENERATING AN ORTHOGONAL SIGNAL FROM SEQUENCES THAT ARE NOT MULTIPLES OF 2^{N}

(76) Inventor: John M. Kowalski, Camas, WA (US)

Correspondence Address: MADSON & AUSTIN, 15 WEST SOUTH TEMPLE, SUITE 900, SALT LAKE CITY, UT, 84101, US

(21) Appl. No.: 11/763,605

(22) Filed: Jun. 15, 2007

(51) Int. Cl. H04L 1/02

(52) U.S. Cl. 375/267

(57) ABSTRACT

A method for generating orthogonal signals is described. A sequence is chosen. A determination is made if the chosen sequence is orthogonal. The sequence is converted from a time domain to a frequency domain if the sequence is not orthogonal. A determination is made if the length of the sequence is a multiple of a first quantity. An Inverse Fast Fourier Transform that is a multiple of the length of the sequence is chosen if the length of the sequence is not a multiple of the first quantity.

### TECHNICAL FIELD

The present invention relates generally to wireless communications and wireless communications-related technology. More specifically, the present invention relates to systems and methods for generating an orthogonal signal from sequences that are not multiples of 2ⁿ.

### BACKGROUND

A wireless communication system typically includes a base station in wireless communication with a plurality of user devices (which may also be referred to as mobile stations, subscriber units, access terminals, etc.). The base station transmits data to the user devices over a radio frequency (RF) communication channel. The term “downlink” refers to transmission from a base station to a user device, while the term “uplink” refers to transmission from a user device to a base station.

Orthogonal frequency division multiplexing (OFDM) is a modulation and multiple-access technique whereby the transmission band of a communication channel is divided into a number of equally spaced sub-bands. A sub-carrier carrying a portion of the user information is transmitted in each sub-band, and every sub-carrier is orthogonal with every other sub-carrier. Sub-carriers are sometimes referred to as “tones.” OFDM enables the creation of a very flexible system architecture that can be used efficiently for a wide range of services, including voice and data. OFDM is sometimes referred to as discrete multi-tone transmission (DMT).

The 3^{rd} Generation Partnership Project (3GPP) is a collaboration of standards organizations throughout the world. The goal of 3GPP is to make a globally applicable third generation (3G) mobile phone system specification within the scope of the IMT-2000 (International Mobile Telecommunications-2000) standard as defined by the International Telecommunication Union. The 3GPP Long Term Evolution (“LTE”) Committee is considering OFDM as well as OFDM/OQAM (Orthogonal Frequency Division Multiplexing/Offset Quadrature Amplitude Modulation), as a method for downlink transmission, as well as OFDM transmission on the uplink.

Wireless communications systems (e.g., Time Division Multiple Access (TDMA), Orthogonal Frequency-Division Multiplexing (OFDM)) usually calculate an estimation of a channel impulse response between the antennas of a user device and the antennas of a base station for coherent receiving. Channel estimation may involve transmitting known reference signals that are multiplexed with the data. Reference signals may include a single frequency and are transmitted over the communication systems for supervisory, control, equalization, continuity, synchronization, etc. Wireless communication systems may include one or more mobile stations and one or more base stations that each transmit a reference signal. Reference signals are orthogonal to each other in order to reduce interference. Reference signals may not include extensions that are orthogonal if the references signals are generated from a non-orthogonal basis set. As such, benefits may be realized from systems and methods that generate orthogonal reference signals from sequences that are not orthogonal. In particular, benefits may be realized from systems and methods that generate orthogonal signals from sequences that are not multiples of 2ⁿ.

### BRIEF DESCRIPTION OF THE DRAWINGS

Exemplary embodiments of the invention will become more fully apparent from the following description and appended claims, taken in conjunction with the accompanying drawings. Understanding that these drawings depict only exemplary embodiments and are, therefore, not to be considered limiting of the invention's scope, the exemplary embodiments of the invention will be described with additional specificity and detail through use of the accompanying drawings in which:

FIG. 1 illustrates an exemplary wireless communication system in which embodiments may be practiced;

FIG. 2 illustrates some characteristics of a transmission band of an RF communication channel in accordance with an OFDM-based system;

FIG. 3 illustrates communication channels that may exist between an OFDM transmitter and an OFDM receiver according to an embodiment;

FIG. 4 illustrates a block diagram of certain components in an embodiment of a transmitter;

FIG. 5 illustrates a sequence generation diagram;

FIG. 6 is a flow diagram illustrating a method for generating orthogonal signals from sequences that are not a power of two;

FIG. 7 is a graph illustrating the correlation when an Inverse Fast Fourier Transform (IFFT) of 192 is applied to a sequence of length 12;

FIG. 8 is a graph illustrating a close up of the correlation when an IFFT of 2048 is applied to a sequence of length 12; and

FIG. 9 illustrates various components that may be utilized in a communications device.

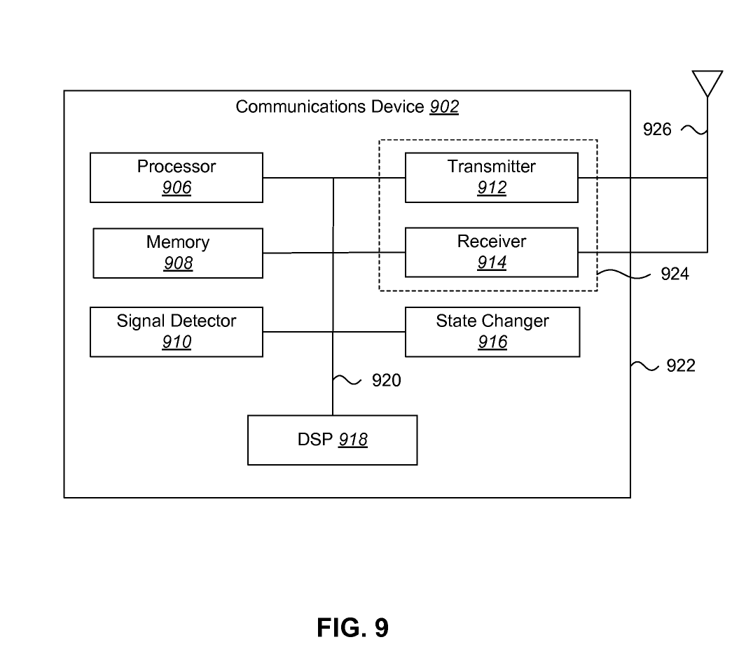

### DETAILED DESCRIPTION

A method for generating orthogonal signals is described. A sequence is chosen. A determination is made if the chosen sequence is orthogonal. The sequence is converted from a time domain to a frequency domain if the sequence is not orthogonal. A determination is made if the length of the sequence is a multiple of a first quantity. An Inverse Fast Fourier Transform that is a multiple of the length of the sequence is chosen if the length of the sequence is not a multiple of the first quantity.

In one embodiment, a determination is made whether the length of the sequence is a power of two. The length of the sequence may be N. The Inverse Fast Fourier Transform may be M=K×2^{L}. In one embodiment, M is a multiple of N. In a further embodiment, K is an odd number. The value L may be a natural number. The length of the sequence may be a multiple of twelve. The length of the Inverse Fast Fourier Transform may be 3×2^{L}. In one embodiment, the sequence is a Zadoff-Chu sequence.

A device that is configured to generate orthogonal signals is also described. The device comprises a processor and memory in electronic communication with the processor. Instructions stored in the memory. A sequence is chosen. A determination is made whether the chosen sequence is orthogonal. The sequence is converted from a time domain to a frequency domain if the sequence is not orthogonal. A determination is made whether the length of the sequence is a multiple of a first quantity. An Inverse Fast Fourier Transform is chosen that is a multiple of the length of the sequence if the length of the sequence is not a multiple of the first quantity.

A computer-readable medium comprising executable instructions for generating an orthogonal signal is also described. A sequence is chosen. A determination is made whether the chosen sequence is orthogonal. The sequence is converted from a time domain to a frequency domain if the sequence is not orthogonal. A determination is made whether the length of the sequence is a multiple of a first quantity. An Inverse Fast Fourier Transform is chosen that is a multiple of the length of the sequence if the length of the sequence is not a multiple of the first quantity.

Various embodiments of the invention are now described with reference to the Figures, where like reference numbers indicate identical or functionally similar elements. The embodiments of the present invention, as generally described and illustrated in the Figures herein, could be arranged and designed in a wide variety of different configurations. Thus, the following more detailed description of several exemplary embodiments of the present invention, as represented in the Figures, is not intended to limit the scope of the invention, as claimed, but is merely representative of the embodiments of the invention.

The word “exemplary” is used exclusively herein to mean “serving as an example, instance, or illustration.” Any embodiment described herein as “exemplary” is not necessarily to be construed as preferred or advantageous over other embodiments.

Many features of the embodiments disclosed herein may be implemented as computer software, electronic hardware, or combinations of both. To clearly illustrate this interchangeability of hardware and software, various components will be described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Where the described functionality is implemented as computer software, such software may include any type of computer instruction or computer executable code located within a memory device and/or transmitted as electronic signals over a system bus or network. Software that implements the functionality associated with components described herein may comprise a single instruction, or many instructions, and may be distributed over several different code segments, among different programs, and across several memory devices.

As used herein, the terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not necessarily all) embodiments of the disclosed invention(s)”, unless expressly specified otherwise.

The term “determining” (and grammatical variants thereof) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

Currently, no uniform means exist to describe different uplink reference signal sequences. In addition, there is no uniform method for generating these sequences, such that when a waveform is generated, converted to continuous time, transmitted, received and synchronously sampled, the received waveform sequence is uniquely recoverable from the transmitting sequence. Although an air interface standard does not generally prescribe a method of implementation for a receiver or a transmitter, the method of generating Discrete Fourier Transform (DFT) spread OFDM waveforms for reference signals determines the performance of a system if the reference signal sequences are not drawn from an orthogonal basis set. DFT-spread OFDM waveforms may be deployed for 3GPP Long Term Evolution standards. The present systems and methods are directed to generating reference signal sequences that include cyclic shifts that are orthogonal even though the sequences are not orthogonal to begin with.

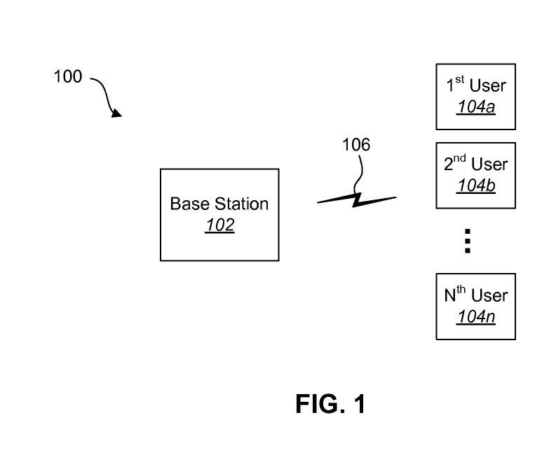

FIG. 1 illustrates an exemplary wireless communication system 100 in which embodiments may be practiced. A base station 102 is in wireless communication with a plurality of user devices 104 (which may also be referred to as mobile stations, subscriber units, access terminals, etc.). A first user device 104a, a second user device 104b, and an Nth user device 104n are shown in FIG. 1. The base station 102 transmits data to the user devices 104 over a radio frequency (RF) communication channel 106.

As used herein, the term “OFDM transmitter” refers to any component or device that transmits OFDM signals. An OFDM transmitter may be implemented in a base station 102 that transmits OFDM signals to one or more user devices 104. Alternatively, an OFDM transmitter may be implemented in a user device 104 that transmits OFDM signals to one or more base stations 102.

The term “OFDM receiver” refers to any component or device that receives OFDM signals. An OFDM receiver may be implemented in a user device 104 that receives OFDM signals from one or more base stations 102. Alternatively, an OFDM receiver may be implemented in a base station 102 that receives OFDM signals from one or more user devices 104.

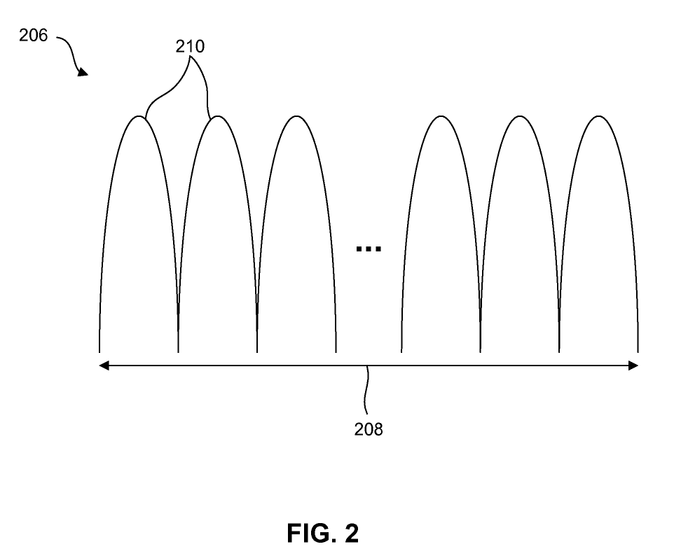

FIG. 2 illustrates some characteristics of a transmission band 208 of an RF communication channel 206 in accordance with an OFDM-based system. As shown, the transmission band 208 may be divided into a number of equally spaced sub-bands 210. As mentioned above, a sub-carrier carrying a portion of the user information is transmitted in each sub-band 210, and every sub-carrier is orthogonal with every other sub-carrier.

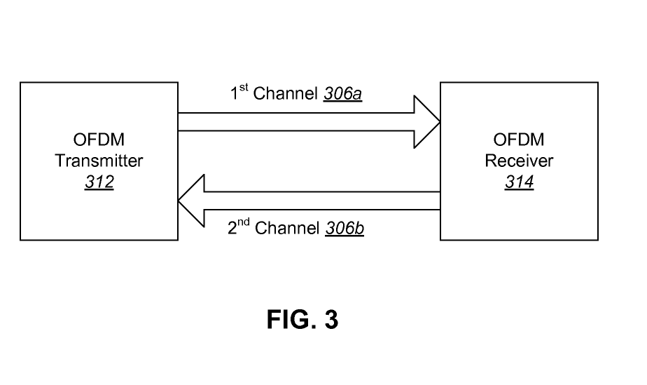

FIG. 3 illustrates communication channels 306 that may exist between an OFDM transmitter 312 and an OFDM receiver 314 according to an embodiment. As shown, communication from the OFDM transmitter 312 to the OFDM receiver 314 may occur over a first communication channel 306a. Communication from the OFDM receiver 314 to the OFDM transmitter 312 may occur over a second communication channel 306b.

The first communication channel 306a and the second communication channel 306b may be separate communication channels 306. For example, there may be no overlap between the transmission band of the first communication channel 306a and the transmission band of the second communication channel 306b.

In addition, the present systems and methods may be implemented with any modulation that utilizes multiple antennas/MIMO transmissions. For example, the present systems and methods may be implemented for MIMO Code Division Multiple Access (CDMA) systems or Time Division Multiple Access (TDMA) systems.

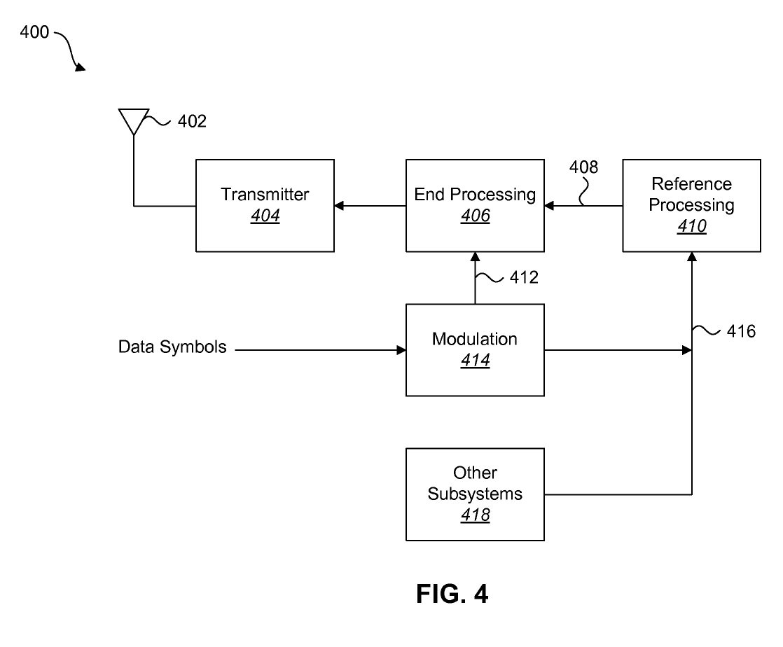

FIG. 4 illustrates a block diagram 400 of certain components in an embodiment of a transmitter 404. Other components that are typically included in the transmitter 404 may not be illustrated for the purpose of focusing on the novel features of the embodiments herein.

Data symbols may be modulated by a modulation component 414. The modulated data symbols may be analyzed by other subsystems 418. The analyzed data symbols 416 may be provided to a reference processing component 410. The reference processing component 410 may generate a reference signal that may be transmitted with the data symbols. The modulated data symbols 412 and the reference signal 408 may be communicated to an end processing component 406. The end processing component 406 may combine the reference signal 408 and the modulated data symbols 412 into a signal. The transmitter 404 may receive the signal and transmit the signal to a receiver through an antenna 402.

The 3GPP Long Term Evolution (LTE) uplink demodulation reference signals may include single-carrier frequency division multiple access (SC-FDMA) symbols. The SC-FDMA symbols in a slot may be transmitted in increasing order of l. A time-continuous signal sₗ(t) in SC-FDMA symbol l in an uplink slot may be defined by:

$${s}_{l} ( t ) = {\sum }_{k = 0}^{{N}_{TX} - 1} {\sum }_{u = 0}^{{N}_{TX} - 1} {a}_{u , l} \cdot {e}^{- j \frac{2 π uk}{{N}_{TX}}} \cdot {e}^{j \frac{2 π ( k + f ( {k}_{0} ) + 1 / 2 )}{{N}_{d} {T}_{s}} ( l - {N}_{CP , l} {T}_{s} )} \\ for 0 \leq t < ( {N}_{CP , l} + {N}_{d} ) \times {T}_{s} . \qquad Equation ( 1 )$$

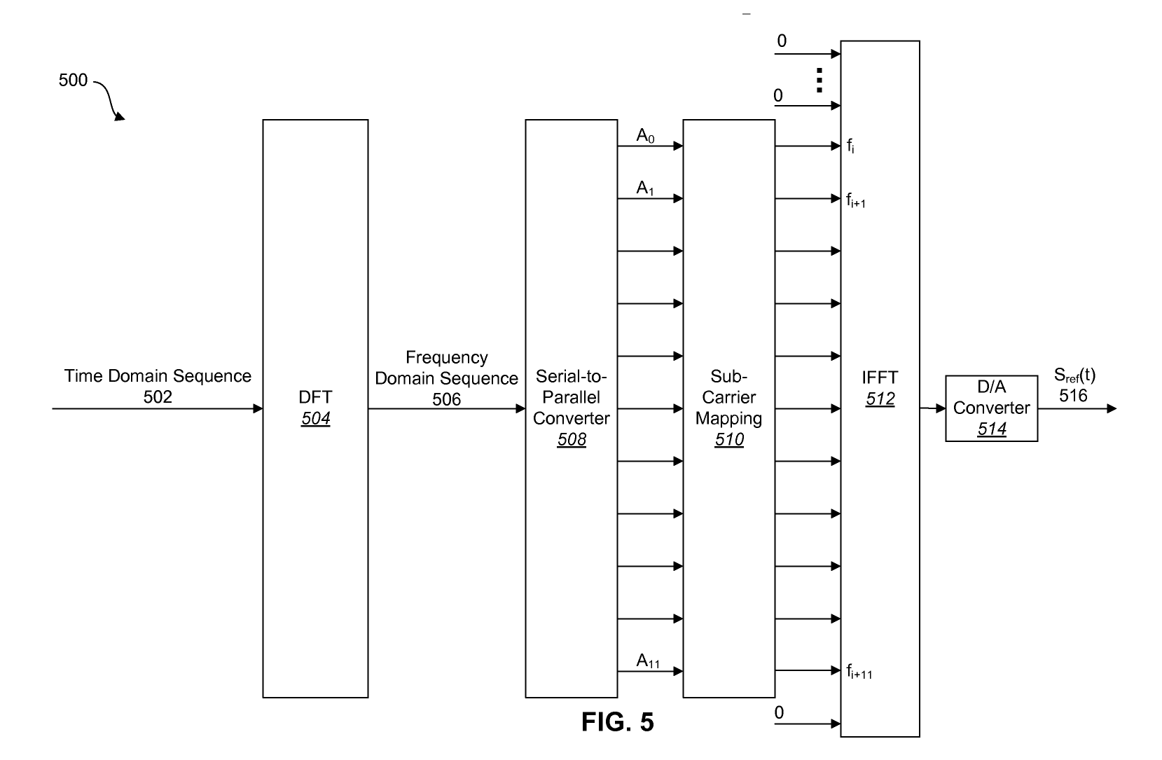

For the uplink reference signal, the {α_{u,l}={α}ᵤ}ᵤ₌₀^{N}^{_{T X}}⁻¹ may be the reference signal sequences, which are transmitted within each slot. FIG. 5 illustrates a sequence generation diagram 500. A time domain sequence 502 may be converted to a frequency domain sequence 506. In one embodiment, a discrete Fourier transform (DFT) 504 converts the time domain sequence 502 to the frequency domain sequence 506. The DFT 504 may be represented by:

$${A}_{k} = {\sum }_{u = 0}^{{N}_{TX} - 1} {a}_{u} \cdot {e}^{- j \frac{2 π uk}{{N}_{TX}}} \qquad Equation ( 2 )$$

A serial-to-parallel converter 508 may be applied to the frequency domain sequence 506. Sub-carriers (A₀ . . . A₁₁) may be mapped using a sub-carrier mapping 510 component. The sub-carrier mapping 510 may map each sub-carrier to an Inverse Fast Fourier Transform (IFFT) 512. In one embodiment, the IFFT 512 is not a power of two. As illustrated, each sub-carrier may be mapped as fᵢ . . . fᵢ₊₁₁. A digital to analog (D/A) converter 514 converts the frequency domain sequence 506 to an analog signal, s_{ref}(t) 516.

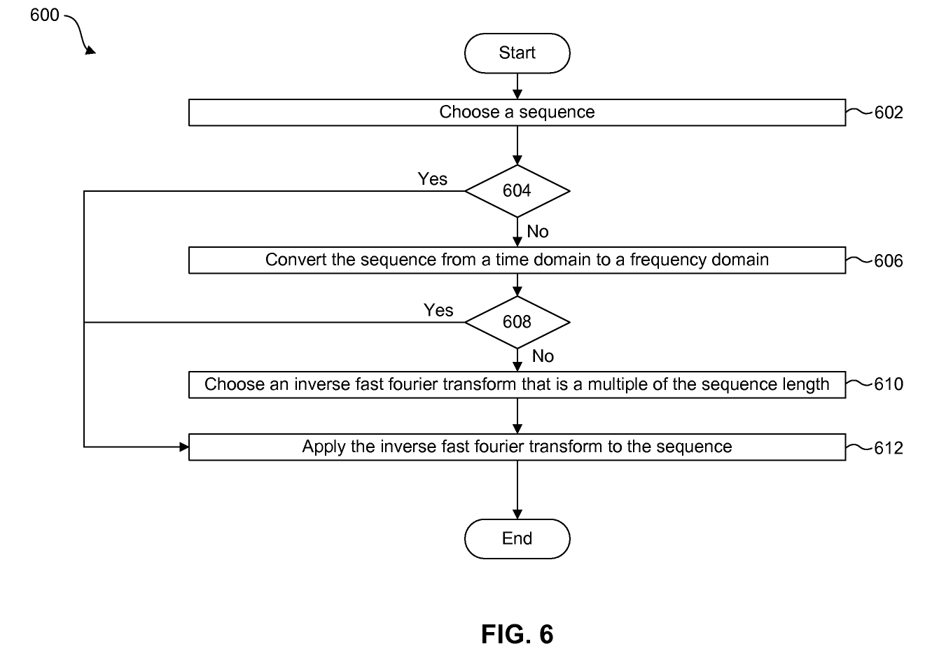

FIG. 6 is a flow diagram illustrating a method 600 for generating orthogonal signals from sequences that are not a power of two. The method 600 may be implemented by a mobile station. A sequence is chosen 602. A determination 604 is made as to whether the chosen sequence is orthogonal. If it is determined 604 that the sequence is orthogonal, an IFFT is applied 612 to the sequence. However, if it is determined 604 that the sequence is not orthogonal, the sequence is converted 606 from a time domain to a frequency domain. It is determined 608 whether the length of the sequence is a multiple of a first quantity. In one embodiment, it is determined 608 if the length of the sequence is a power of two. If the length is a power of two, the IFFT is applied 612 to the sequence. However, if the length of not a power of two, the signal s_{ref}(t) 516 may include cyclic shifts that are not orthogonal. As such, an IFFT is chosen 610 that is multiple of the sequence length and this IFFT is applied to the sequence 612.

In other words, if the length of the sequence is N, then the IFFT chosen 610 to generate the sequence may be a number M=K×2^{L}, where M may be a multiple of N, K is an odd number and L is a natural number. In particular, if the sequence length is a multiple of 12, then the IFFT may be chosen 610 so that it is a length of the form 3×2

Typically, fast Fourier transforms are generated based on lengths of sequences that are powers of two in order to minimize computations. However, for 3GPP LTE waveforms that are not orthogonal, the orthogonal basis may be generated by cyclic shifts of the time domain sequence 502 that is the output of the IFFT 512. In one embodiment, this waveform will have cyclic correlation sign changes by virtue of there being an implicit sin(x)/x convolution. However, in the sequence domain, the correlation may approach zero provided the IFFT length is a multiple of the underlying sequence length.

FIGS. 5 and 6 illustrate systems and methods for an IFFT to generate the

$${e}^{j \frac{2 π ( k + f ( {k}_{0} ) + 1 / 2 )}{{N}_{d} {T}_{s}} ( t - {N}_{CP , l} {T}_{s} )}$$

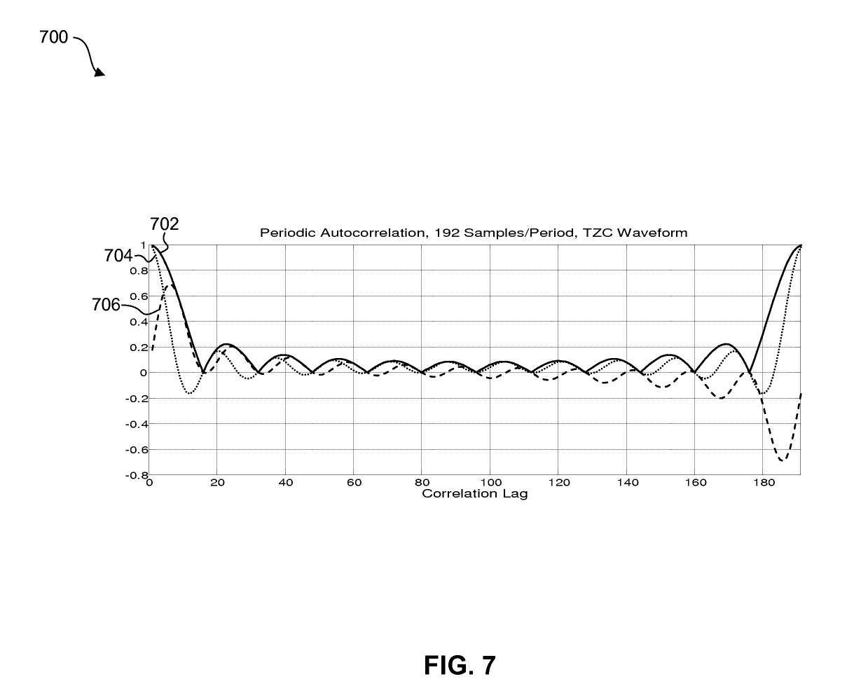

term. As previously stated, the IFFT does not necessarily need to be a power of two. For example, when the IFFT is 192 in length, an autocorrelation function, such as in FIG. 7, results. With the numerology as shown in FIG. 7, zeros occur at multiples of 16 samples, which may be an integer number of 1/12 of the overall IFFT sequence length (at 32 samples, e.g., the correlation may be 90 dB below the peak, due to finite precision arithmetic). FIG. 7 is a graph 700 illustrating the correlation when an IFFT of 192 is applied to a sequence of length 12. The graph 700 of FIG. 7 illustrates a magnitude of autocorrelation 702, a real part 704 and an imaginary part 706.

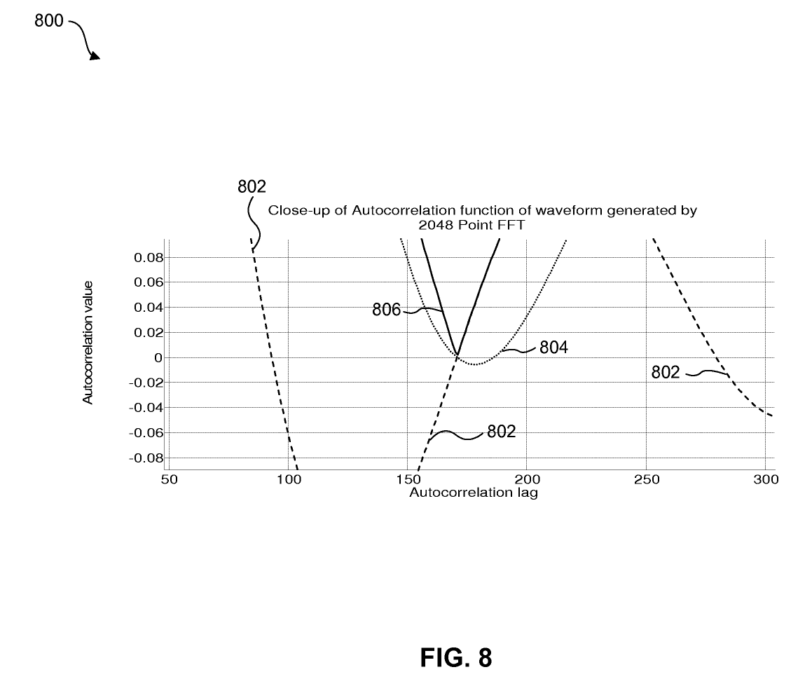

FIG. 8 is a graph 800 illustrating a close up of the correlation when an IFFT of 2048 is applied to a sequence of length 12. If a 2048 point IFFT is used, an autocorrelation function would have a property as illustrated in FIG. 8. The graph 800 of FIG. 8 illustrates a magnitude of autocorrelation 806, a real part 802 and an imaginary part 804. As shown, with a 2048 point IFFT applied to a sequence of length 12, the minimum correlation may be down 54 dB. In one embodiment, an estimation may be made for the 2048 point IFFT that the correlation loss will be at least 0.2 dB due to cyclically shifted signals not being truly orthogonal at sequence sampling points.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array signal (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention.

What is claimed is:

1. A method for generating orthogonal signals, the method comprising:
choosing a sequence;
determining if the chosen sequence is orthogonal;
converting the sequence from a time domain to a frequency domain if the sequence is not orthogonal;
determining if the length of the sequence is a multiple of a first quantity; and
choosing an Inverse Fast Fourier Transform that is a multiple of the length of the sequence if the length of the sequence is not a multiple of the first quantity.

2. The method of claim 1, further comprising determining if the length of the sequence is a power of two.

3. The method of claim 1, wherein the length of the sequence is N.

4. The method of claim 3, wherein the Inverse Fast Fourier Transform is M=K×2^{L}.

5. The method of claim 4, wherein M is a multiple of N.

6. The method of claim 4, wherein K is an odd number.

7. The method of claim 4, wherein L is a natural number.

8. The method of claim 1, wherein the length of the sequence is a multiple of twelve.

9. The method of claim 8, wherein the length of the Inverse Fast Fourier Transform is 3×2^{L}.

10. The method of claim 1, wherein the sequence is a Zadoff-Chu sequence.

11. A device that is configured to generate orthogonal signals, the device comprising:
a processor;
memory in electronic communication with the processor;
instructions stored in the memory, the instructions being executable to:
choose a sequence;
determine if the chosen sequence is orthogonal;
convert the sequence from a time domain to a frequency domain if the sequence is not orthogonal;
determine if the length of the sequence is a multiple of a first quantity; and
choose an Inverse Fast Fourier Transform that is a multiple of the length of the sequence if the length of the sequence is not a multiple of the first quantity.

12. The device of claim 11, wherein the device is a mobile communications device.

13. The device of claim 11, wherein the instructions are further executable to determine if the length of the sequence is a power of two.

14. The device of claim 11, wherein the length of the sequence is N.

15. The device of claim 14, wherein the Inverse Fast Fourier Transform is M=K×2^{L}.

16. The device of claim 15, wherein M is a multiple of N.

17. The device of claim 15, wherein K is an odd number.

18. The device of claim 15, wherein L is a natural number.

19. The device of claim 11, wherein the length of the sequence is a multiple of twelve and the length of the Inverse Fast Fourier Transform is 3×2^{L}.

20. A computer-readable medium comprising executable instructions for generating an orthogonal signal, the instructions being executable to:
choose a sequence;
determine if the chosen sequence is orthogonal;
convert the sequence from a time domain to a frequency domain if the sequence is not orthogonal;
determine if the length of the sequence is a multiple of a first quantity; and
choose an Inverse Fast Fourier Transform that is a multiple of the length of the sequence if the length of the sequence is not a multiple of the first quantity.
